(19) United States
(12) Patent Application Publication
(10) Pub. No.: US 2014/0146636 A1
(43) Pub. Date: May 29, 2014

(54) MIXER CHIP

(71) Applicant: PHOTRONICS, INC., Brookfield, CT (US)

(72) Inventor: Brian W. DILLION, Carrollton, TX (US)

(73) Assignee: PHOTRONICS, INC., Brookfield, CT (US)

(21) Appl. No.: 13/829,155

(22) Filed: Mar. 14, 2013

Related U.S. Application Data
(60) Provisional application No. 61/730,787, filed on Nov. 28, 2012.

(51) Int. Cl. B01F 5/06; C03C 15/00; B01F 15/00; B01F 13/00

(52) U.S. Cl. CPC B01F 5/0603; B01F 13/0059; C03C 15/00; B01F 15/00922
USPC 366/337; 216/10

(57) ABSTRACT

A microfluidic mixer including one or more mixer channels, each of the mixer channels having at least one glass surface on which are formed protrusions arranged in a herringbone pattern.

### RELATED APPLICATION

This application is a non-provisional based on U.S. Provisional Patent Application Ser. No. 61/730,787, filed Nov. 28, 2012, the contents of which are incorporated herein by reference in their entirety.

### FIELD

The present disclosure generally relates to fluidic chips, and in particular to microfluidic chips including at least one mixer.

### SUMMARY

According to exemplary embodiments of the present disclosure, microfluidic mixer chips are formed in glass substrates using micro lithography techniques. Various channel patterns and combinations thereof may form various elements, such as, for example, one or more mixers. Such mixers may include channels that follow a spiral pattern. The microfluidic mixer chips may also include micro-pores for input and outputs, and holes of micro pillar arrays. The one or more spiral mixers may be integrated with other elements on the microfluidic chips, such as, for example various inputs and output, arrays, lines, tees, crosses, channels, etc.

A microfluidic mixer according to an exemplary embodiment of the present invention comprises: one or more mixer channels, each of the mixer channels comprising at least one glass surface on which are formed protrusions arranged in a herringbone pattern.

According to at least one embodiment, the glass surface is made of fused silica or borosilicate glass.

According to at least one embodiment, at least one glass surface of at least one mixer channel forms a bottom wall of the at least one mixer channel, and the protrusions are formed only in the bottom wall.

According to at least one embodiment, at least one glass surface of at least one mixer channel forms a bottom wall and a side wall of the at least one mixer channel, and the protrusions are formed in the bottom wall and extend into the side wall.

According to at least one embodiment, the protrusions have a height within the range of 1 um to 100 um.

According to at least one embodiment, a distance between the protrusions is within a range of 1 um to 500 um.

A method of forming a microfluidic mixer according to an exemplary embodiment of the present invention comprises the steps of: providing a glass substrate; and etching the glass substrate so as to form protrusions arranged in a herringbone pattern.

According to at least one embodiment, the etching step is performed using an isotropic etchant.

According to at least one embodiment, the etching step is performed using a wet etchant.

According to at least one embodiment, the method further comprises a step of forming a patterned hard mask layer over the substrate before the etching step, so that the glass substrate is undercut relative to the patterned hard mask during the etching step.

According to at least one embodiment, the glass is photostructuable glass, and the method further comprises the step of activating portions of the glass substrate so that the activated portions are removed during the etching step.

### BRIEF DESCRIPTION OF THE DRAWINGS

The objects, features and advantages of the present disclosure will be more fully understood by reference to the following, detailed description when taken in conjunction with the accompanying figures, wherein:

FIG. 1A is a flowchart illustrating a method for manufacturing microfluidic chips according to exemplary embodiments;

FIG. 1B shows cross-sectional views of a substrate representing a process of forming channels on the substrate according to exemplary embodiments;

FIG. 2A is a three-dimensional view of a microfluidic mixer chip with a two-fluid input according to exemplary embodiments;

FIG. 2B is a three-dimensional magnified view of a section of microfluidic chip with a two-fluid input mixer, according to exemplary embodiments;

FIG. 3 is a three-dimensional view of a microfluidic mixer chip with a three-fluid input according to exemplary embodiments;

FIG. 4 is a three-dimensional view of a microfluidic mixer chip with two mixers according to exemplary embodiments;

FIG. 5 is a three-dimensional view of a microfluidic mixer chip with a serpentine mixing section according to exemplary embodiments;

FIG. 6 is a three-dimensional view of a microfluidic chip with micro pillar arrays according to exemplary embodiments; and

FIG. 7 is a three-dimensional view of a microfluidic mixer chip according to exemplary embodiments.

FIG. 8 is a perspective view of a channel of a mixer chip according to an exemplary embodiment of the present invention;

FIGS. 9A-9E are cross-sectional views showing various steps of a method for forming a mixer chip according to an exemplary embodiment of the present invention;

FIGS. 10A and 10B shows herringbone patterns formed using the method of forming a mixer chip according to an exemplary embodiment of the present invention; and

FIGS. 11A-11D are cross-sectional views showing various steps of a method for forming a mixer chip according to another exemplary embodiment of the present invention.

### DETAILED DESCRIPTION

Various exemplary embodiments of the present disclosure are directed to microfluidic chips and methods of manufacturing microfluidic chips. Microfluidic chips may be used in any number of applications including but not limited to medical devices, life sciences, sensors, etc.

Various exemplary embodiments of the present disclosure relate to fluidic chips manufactured from a substrate. The substrate may have one or more layers that are substantially transparent. The substrate may be made of materials such as, for example glass or ceramic. Various types of glass may be used including but not limited to fused silica, ceramic, and/or other suitable materials, such as photo-structurable glass, or material comprising superior optical properties and biocompatibility. For example, APEX™ Glass, a photo-structurable material, may be used. In exemplary embodiments, wafers of APEX™ Glass comprising approximately 100 mm to 150 mm diameter wafers, and having a thickness of approximately 0.5 mm to over 4 mm, may be used. However, other sized wafers of APEX™ glass may also be used depending on application or need. For example, in exemplary embodiments, microscope slide sized wafers, such as, for example wafers ranging in size from approximately 25×76×1 mm to 25×76×0.5 mm may be used.

Formation of channels on APEX glass and/or related materials are described in more detail in U.S. patent application Ser. Nos. 12/058,608 and 12/058,588, the disclosures of which are incorporated herein by reference in their entireties.

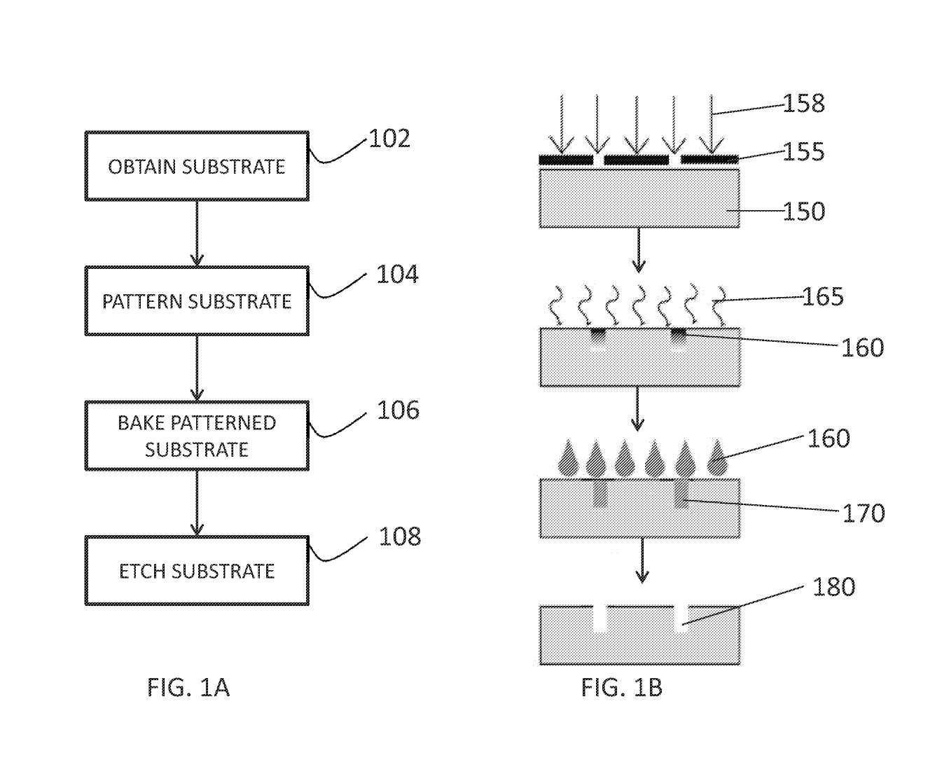

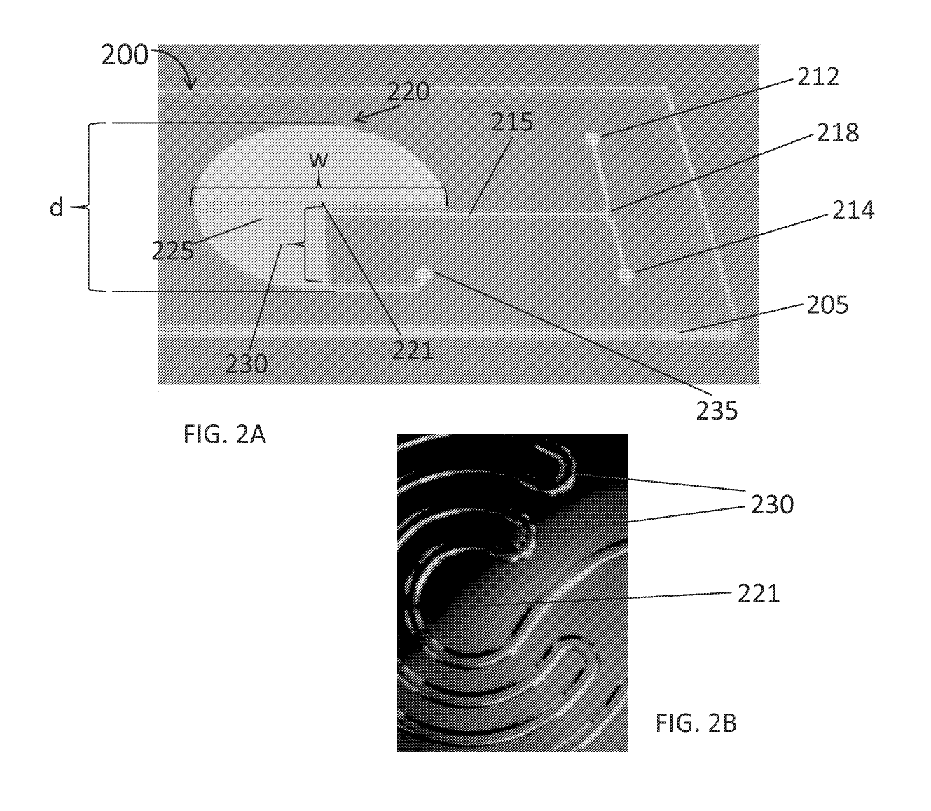

FIG. 1A shows a flowchart describing a method for manufacturing a microfluidic pattern within a substrate according to exemplary embodiments. FIG. 1B shows a series of diagrams illustrating a process of creating a patterned microfluidic structure according to exemplary embodiments.

Referring to FIG. 1A, in step 102, a suitable substrate is provided. In various exemplary embodiments, optically transparent substrates made from, for example, glass may be provided. In some exemplary embodiments, the provided substrate may be polished. In some exemplary embodiments, the provided substrate may not need to be polished, depending upon the intended application. In step 104, the obtained substrate may be photo-patterned according to any suitable process. For example, referring to FIG. 1B, a photomask 155 may be placed on a substrate 150 and exposed to a high-energy source, such as, for example, ultraviolet (UV) light. Common energy sources with wavelengths of 365 nm, 248 nm, or 193 nm and also less common wavelengths of 157 nm, 13.5 nm, X-rays, electrons, and ions may be used. In embodiments, APEX™ Glass, for example, may use a 310 nm wavelength energy source.

In exemplary embodiments, various types of photomasks may be used, such as, for example, binary masks or phase shift masks, and/or patterned photoresist may be placed on top of a substrate before UV light application.

Application of UV light or other energy sources may alter or transform the exposed parts of the substrate. In exemplary embodiments, exposing APEX™ Glass may alter or transform the structure of the exposed substrate.

Referring to FIG. 1A, in step 106, according to exemplary embodiments, an exposed substrate may be exposed to heat, such as by baking. While the heat application may be done through a furnace or oven, in various exemplary embodiments other heat sources may be used to apply heat to the substrate. The baking process may be done once, or multiple times at different temperatures for different lengths of time. In embodiments where APEX™ glass is the provided substrate, the baking process may be made up of two steps. The first step can include baking the substrate in an oven at a first temperature, such as, for example 500° C. for a period of time, such as, for example, 75 minutes. The next step may be baking the substrate at a higher temperature, such as 575° C. for another period of time, such as, for example, 75 minutes.

Referring to FIG. 1B, in exemplary embodiments, the heat 165 may transform UV exposed regions of the substrate 160. For example, the heating may transform exposed regions of the APEX™ glass or any other similar material into ceramic.

In step 108, the baked substrate may be subjected to an etching process. FIG. 1B, for example, shows a UV photo-patterned and baked substrate having transformed regions 170. These regions may be etched according to any suitable etching process, such as, for example, dry or wet etch. FIG. 1B shows an exemplary embodiment in which a wet etch 160 is used.

Referring to FIG. 1B, as a result of etching, channels 180 may be formed in the substrate 150. The dimensions of the channels may depend on the parameters of photo-pattern, UV exposure, baking and etching processes. For example, the channels may be formed with various dimensions, with the height of each channel ranging from approximately 100 nm to 1 mm. In other words the channel height may be only very shallow with respective to the substrate, or the channel may form through the substrate, sometimes referred to as a through-glass-via (TGV). The width of each channel may range from approximately 1 um to 500 um.

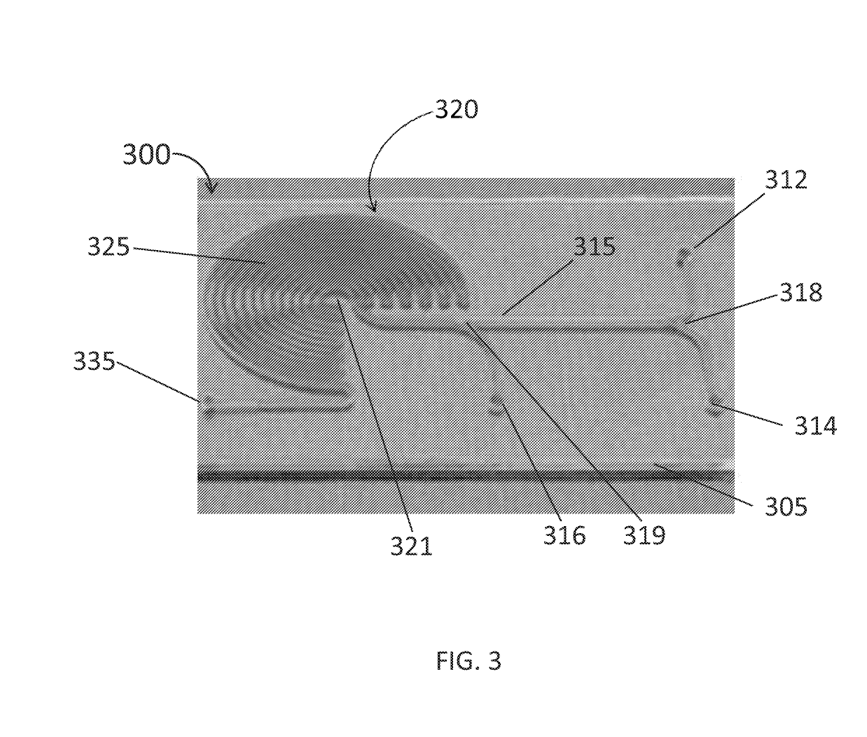

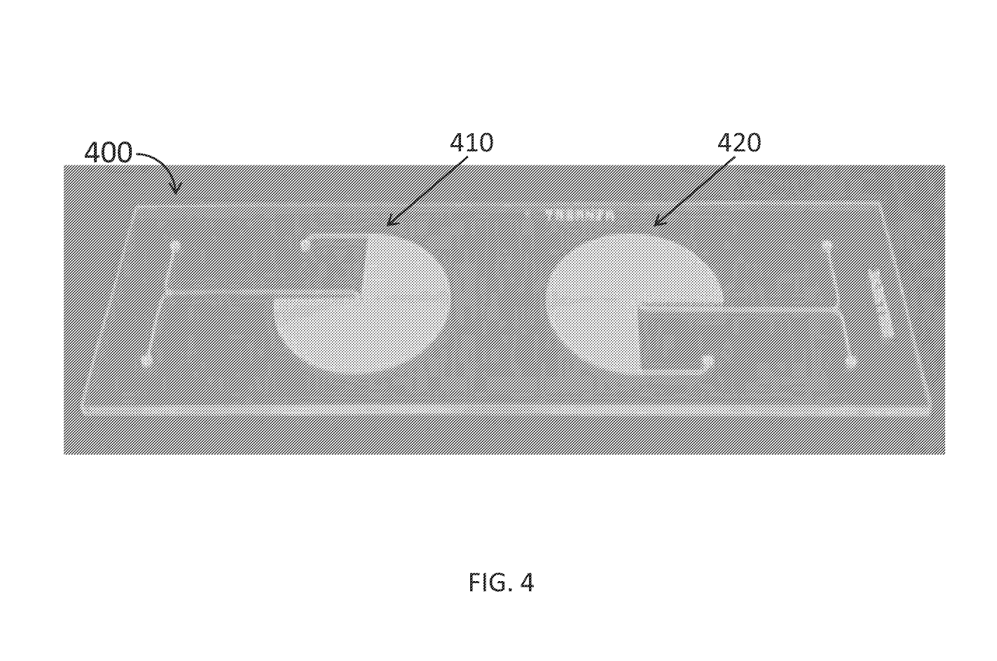

According to exemplary embodiments of the present disclosure, various channel patterns may be formed using the exemplary techniques described above so as to form different types of elements. For example, FIG. 2A shows a microfluidic chip generally designated by reference number 200 comprising a microfluidic spiral mixer 220 formed on a glass substrate 205 according to exemplary embodiments of the present disclosure. Any suitable substrate may be used, such as, for example, substrates that may be characterized as inert, and capable of handling various biological materials as well as various types of chemicals. The mixer 220 may comprise channels formed in the substrate 205 using the above-described techniques.

The microfluidic mixer 220 may include fluid inputs 212 and 214. In this regard, according to exemplary embodiments, one or more fluids may enter the mixer 220 and flow into a channel formed in the substrate through the fluid inputs 212 and 214, which may be, for example, micro-pores, or other types of precision holes. According to at least one exemplary embodiment, the mixer 220 may include a lid bonded to a base, and the fluid inputs may be formed in the lid and/or the base. In exemplary embodiments, TGV can be formed using hydrofluoric acid (HF) etching, ultrasonic etching, Computer Numerical Control (CNC) drilling, or laser ablation. In embodiments where APEX™ glass is used, the pores can have average pore diameters in the range of approximately 0.5 mm to 2.0 mm, and can be customized for a wider range.

Referring to FIG. 2A, according to exemplary embodiments, channels starting at each of the fluid inputs 212, 214 may extend in various directions, such as, for example, towards or away from one another. In the exemplary embodiment shown in FIG. 2A, the channels may combine with each other to form a third channel 215, at junction 218. The junction 218 may be a Y-junction or any other structure where two or more channels may meet and combine and/or merge.

In exemplary embodiments, a merged channel from junction 218 may extend in a same or a direction different than other channels meeting at the junction. For example, referring to FIG. 2A, the combined channel 215 extends in a direction approximately perpendicular to the channels from the first input 212 and the second input 214. The combined channel 215 may lead to another section or element, such as, for example, a spiral mixing section 225. The mixing section 225 may include a channel that traces, at least in part, a circumferential path around a fixed center point. The radial distance the channel extends away from the fixed center may increase or decrease continuously, or may increase or decrease at certain locations.

In the exemplary embodiment show in FIG. 2A, the mixing section 225 may not fully wrap around or encircle around a center-fixed point 221. In this regard, one or more channels of mixing section 225 may trace circumferential paths that cover, for example, approximately three-fourths (¾ths) or 270° around the fixed center point 221.

It should be appreciated that in, various exemplary embodiments, a mixing section may wrap a different amount around a center point than the exemplary embodiments show in FIG. 2A. For example, the channels may only wrap half-way) (180° (forming a spiral semi-circle), a quarter-way, or any other feasible degree less than 360°. However, in microfluidics chips containing channels with varying depths, the spiral channel may wrap more than 360° and not intersect itself or other elements.

FIG. 2B is an enlarged view of the center or bulls-eye of spiral mixing section 225 and shows a channel tracing a circumferential path. Referring to FIGS. 2A and 2B, at curve back locations 230, a channel in the spiral mixing section 225 bends back so that the distance/radius from the channel to the center 221 increases. This distance may increase by a fixed amount, or can vary in any number of ways, such as, for example constantly increasing/decreasing, increasing then decreasing, linearly increasing, exponentially increasing, and etc.

Referring to FIG. 2A, the curve back locations 230 may be aligned. In other exemplary embodiments, the curve back locations may be varied, according to numerous configurations of the spiral section.

Further, the spiral mixing section 225 is not limited to a channel tracing a circumferential or circular-like path. A circular type spiral wrap may be one of the most space or real-estate efficient two-dimensional structures, but other, geometries may be implemented including but not limited to ovals, ellipses, and any other suitable geometric patterns, etc.

In exemplary embodiments, two or more combinatory fluids may be introduced into mixer 220. The mixer 220 may increase contact between the combinatory fluids. For example, referring to FIG. 2A, a channel of spiral mixing section 225 continually curves circumferentially and may reverse direction. Combinatory fluids following such a circumferential flow with reversal of directions may result in the cross and exchange of chemicals between the fluids. Without being bound by theory, the general mixing action may occur in the turn where the fluids with the higher specific gravity may be forced to the outside of the turn during flow. So, if the turns alternate direction, as they do in the spiral mixing section, then the fluids should mix. In the spiral mixing section 225, there are no straight pieces or lines. The spiral mixing section includes arcs of different longer radius interconnected with short approximately 180 degree turns.

In exemplary embodiments, the channels making up the spiral mixing section may have widths within the range of 1-500 um and depths within the range of 1 um to 200 um, with the number of loops dependent on sizing dimensions and area available.

Referring back to FIG. 2A, the combinatory fluids may follow a channel exiting from spiral mixing section 225 to a fluid output 235. The fluid output 235 may include a micro-pore for allowing the exit of any fluids. It should be appreciated that the spiral mixing section 225 may lead to various elements, such as, for example, filters, mixers, lines, tees, crosses, arrays. For example, particularly in the case of a standard microscope slide, the spiral mixing section 225 may lead to one or more other mixing sections.

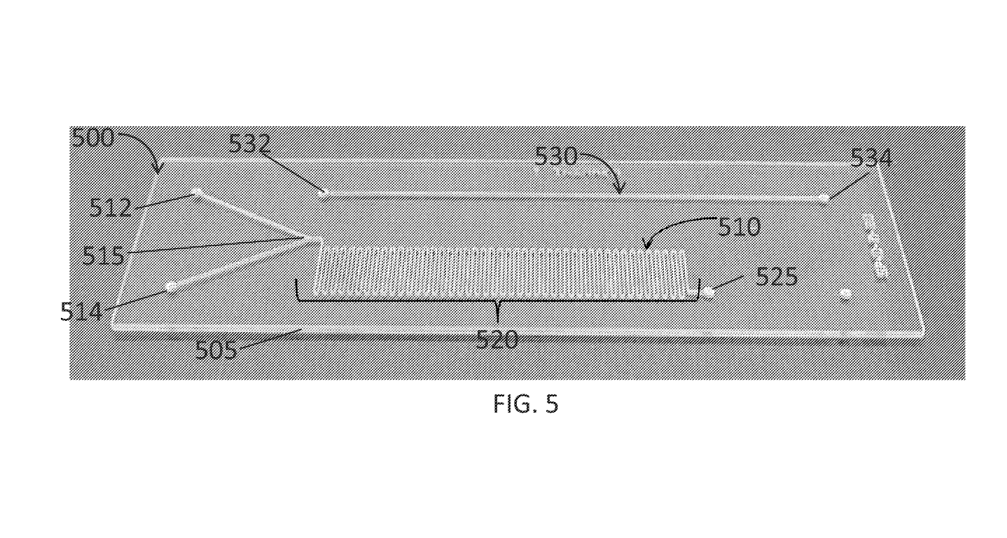

FIG. 3 shows a microfluidic chip 300, according to exemplary embodiments, including fluid inputs, 312, 314 and 316, and mixer 320. Channels may extend from fluid inputs 312 and 314 so as to meet and combine at a junction 318. Combined channel 315 may extend from junction 318 to junction 319 and merge with a channel extending from fluid input 316. This configuration is only meant to be exemplary and not a limitation, as other configurations may be implemented for combining channels from multiple inputs. For example, the channels from multiple inputs may combine at one junction, or multiple junctions.

Referring to FIG. 3, a combined channel extending from junction 319 traces a path into the mixing section 325. According the exemplary embodiments, the mixing section 325 may be implemented as a channel circumferentially spiraling three-fourths around a center 321. As explained herein, a mixing section may be implemented in numerous variations, including variations to geometry, curve back locations, distance from channel to center, etc.

Mixer 320 may include a channel exiting the spiral section 325 and leading to a fluid output 335.

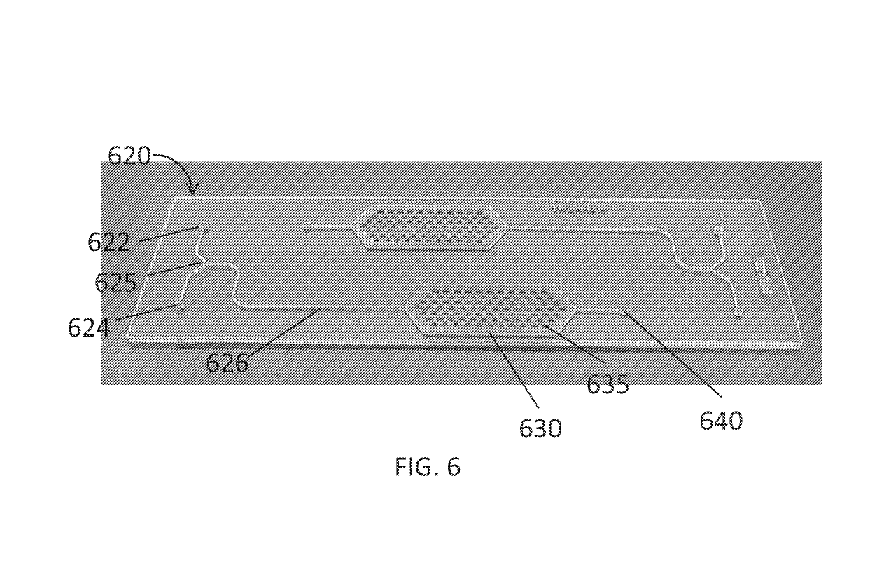

The compact nature of a spiral mixing section may allow multiple elements on a single chip. In this regard, referring to FIG. 4, a microfluidic chip 400, according to an exemplary embodiments, may include mixers 410 and 420. The chip 400 may be, for example, 25×76 mm, with mixers made up of channels having widths within the range of 1-500 um, and depths within the range of 1 um to 200 um.

FIG. 4 shows merely one configuration, where mixer 420 is a horizontal and vertical mirror image of mixer 410. However, in other exemplary embodiments the mixers may be arranged in various formations and/or configurations where the mixers may have various orientations. Moreover, a chip may include any number of mixers and may include additional elements, such as, for example filters, lines, crosses, tees, holes and any other suitable elements.

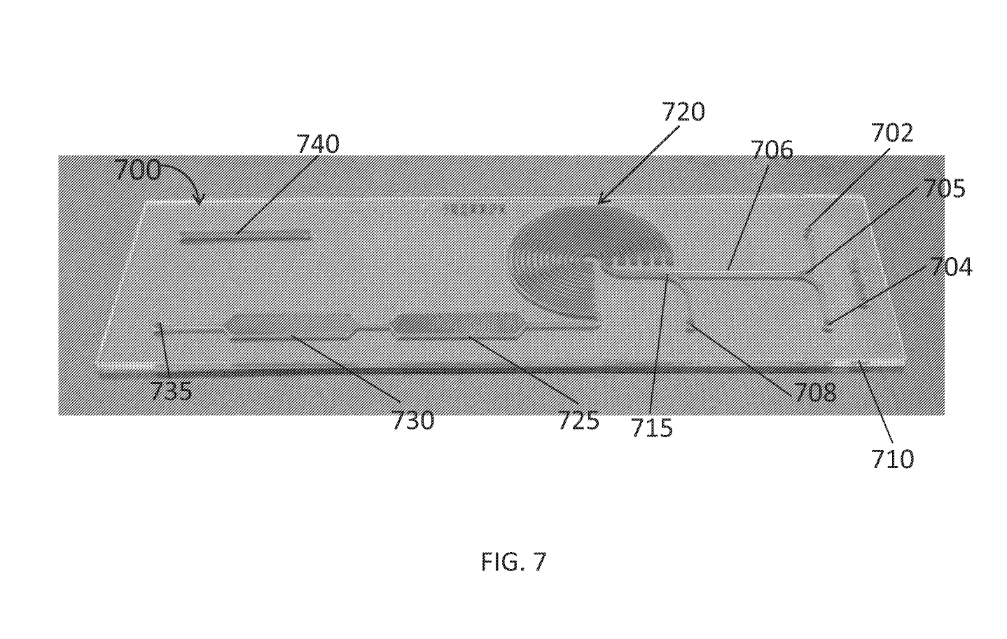

FIG. 5 shows a microfluidic chip, generally designated by reference number 500, according to an exemplary embodiment of the present disclosure. The chip 500 may include substrate 505, a mixer 510 and a line 530. The line 530 may simply be a channel that traces a straight path and which may connect an input 532 and an output 534 or multiple inputs and outputs.

The mixer 510 may include a sinusoidal or serpentine mixing section 520. The mixer 510 may include one or more fluid inputs, such as, for example, inputs 512 and 514 that interface with channels that meet at junction 515. A merged channel may lead from the junction 515 to mixing section 520. The serpentine mixing section 520 may allow combinatory fluids that flow through to mix and exchange chemicals or other matter with one another.

In exemplary embodiments, the mixing section 520 may be implemented in various ways. For example, the channel in mixing section 520 may trace sinusoidal-like waves, with the waves comprising various heights and/or widths. The channel in the mixing section 520 may trace other types of waves, such as, for example, square waves, triangle waves, etc., with different heights, widths, spacing, etc.

A channel may lead from mixing section 520 to any other suitable element. Referring to FIG. 5A, the mixing section 520 may lead to a fluid output 525, which may be implemented according to exemplary embodiments discussed herein.

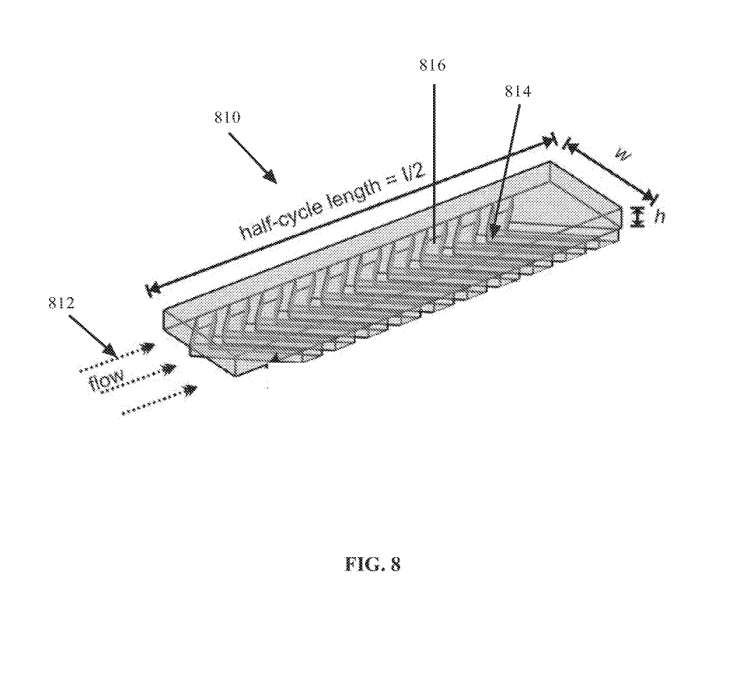

FIG. 6 shows a microfluidic mixer chip, generally designated by reference number 620, according to exemplary embodiments, including micro pillar arrays 630. Each micro pillar array 630 may include an array of holes or micro-pores 635 aligned in various configurations. The micro pillar arrays 630 may be used to create turbulent flow for particle mixing.

The chip 620 may include one or more fluid inputs 622 and 624 that connect to channels that may lead to a junction 625. A combining channel 626 may lead from junction 625 to one or more elements, for example, the micro pillar array 630. In exemplary embodiments, a channel may exit from the micro pillar array 630 and may lead to one or more other elements, such as, for example, a fluid output 640.

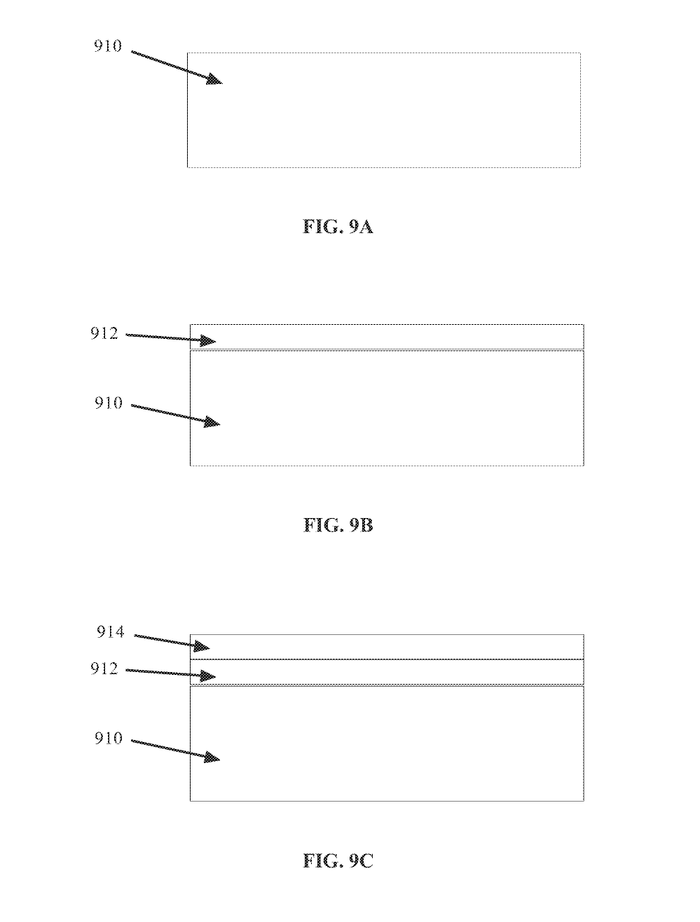

FIG. 7 shows a microfluidic chip, generally designated by reference number 700, according to exemplary embodiments. The chip 700 may include a substrate 710 made from, for example, glass, ceramic, APEX™ glass, etc. The chip 700 may include a spiral mixer 720 connected in series to micro pillar arrays 725 and 730. The chip 700 may also comprise one or more lines 740.

According to exemplary embodiments, the spiral mixer 720 may include one or more fluid inputs, 702, 704 and 708 that may combine at one or more junctions 705, 715. Spiral mixer 720 may include a channel that traces a circumferential spiral-like pattern. Spiral mixer 720 may lead to various additional elements, such as, for example, a series of micro pillar arrays 725 and 730. In various exemplary embodiments, other elements may be included and integrated with the mixer. For example, in FIG. 7, the output from the micro pillar 730 may lead to a fluid output 735.

Referring to FIG. 7, one or more types of fluids, liquids, solutions, etc. may be introduced into the fluid inputs 702, 704 and 708. The fluids may be pushed, sucked, or pressurized through the one or more elements, including, for example, the spiral mixer 720 and the one or more micro pillar arrays 725 and 730. In an exemplary embodiment, the fluids may be moved through the one or more elements using a micro-pump. The resultant combinatory fluid(s) may be extracted at one or more fluid outputs 735.

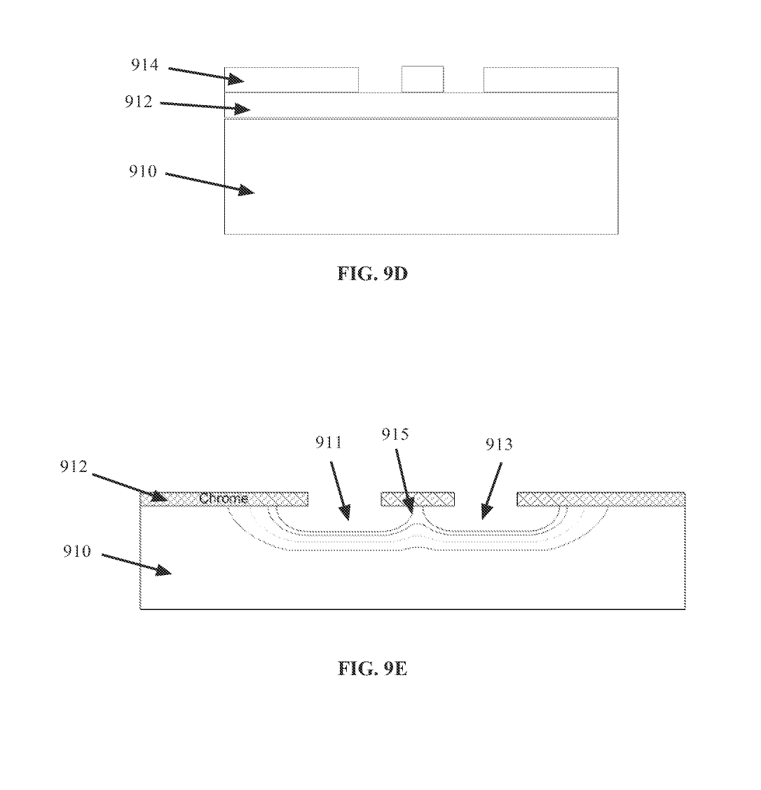

FIG. 8 is a three-dimensional view of a channel, generally designated by reference number 810, of a mixer chip according to an exemplary embodiment of the present invention. As shown by arrows 812, a fluid may flow in a principal direction through the channel 810. The channel 810 includes a channel surface 814 having a plurality of chevron-shaped protrusions 816 formed in at least a portion of the channel surface 814. That is, the protrusions 816 form a “herringbone” pattern. In the Stokes flow regime, where viscous forces dominate, the herringbone pattern of the protrusions 816 cause transverse flow in the channel 810 resulting in two counter-rotating vortices along the channel length. The vertices of the protrusions 816 may be offset to approximately one third of the way across the channel width, and each set of herringbones may alternate with a complementary set, mirrored across the centerline of the channel, to create a full mixing cycle. This alternation reorients the flow periodically so as to improve mixing.

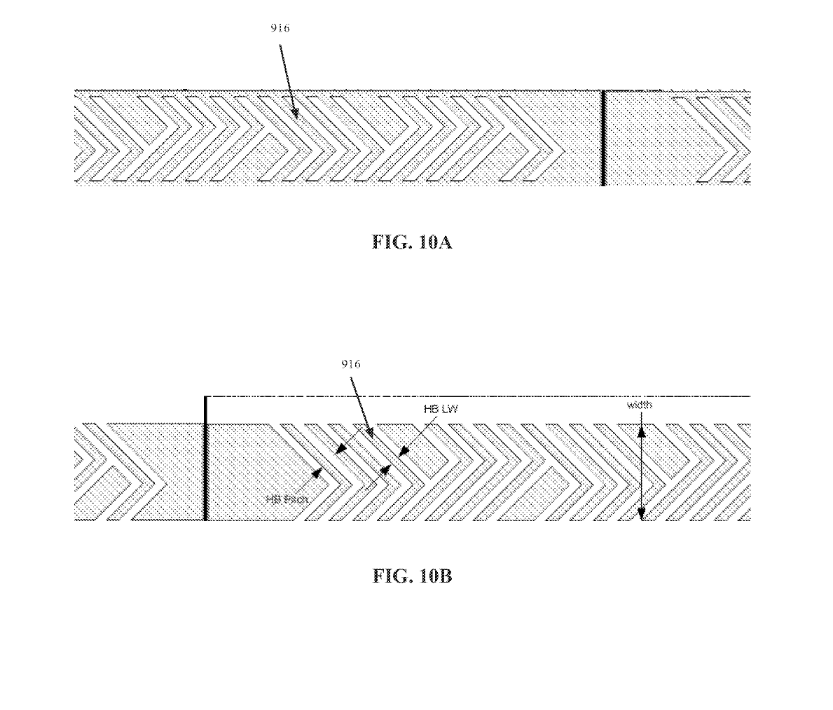

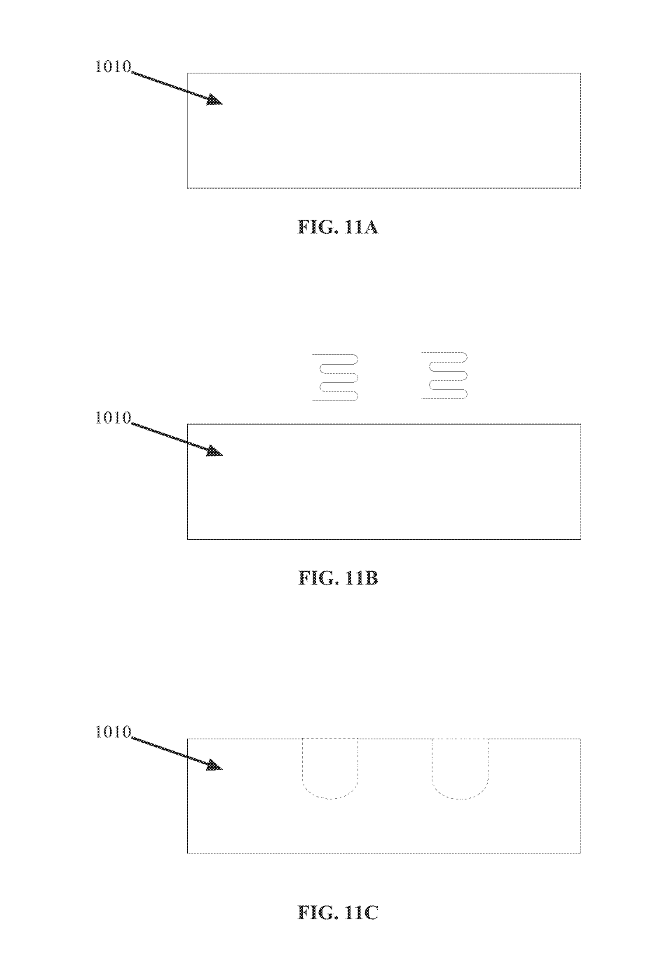

FIGS. 9A-9E are cross-sectional views showing various steps of a method for forming a mixer chip according to an exemplary embodiment of the present invention. As shown in FIG. 9A, a substrate 910 is provided. The substrate 910 may be made of, for example, fused silica or borosilicate glass. As shown in FIG. 9B, a hard mask 912 is deposited on the substrate 910. The hard mask 912 may be made of, for example, a nitride, an oxide or a metal. In an exemplary embodiment, the hard mask 912 is made of chrome. As shown in FIG. 9C, a photoresist layer 914 is deposited over the hard mask 912 by, for example, spin coating. The photoresist layer 914 may be made of any suitable photoresist material, such as, for example, poly(methyl methacrylate) (PMMA). As shown in FIG. 9D, a pattern is formed in the photoresist layer 914 using a lithography technique, such as, for example, photolithography, X-ray lithography or electron beam lithography. The removal of portions of the photoresist material during this patterning step results in spaces between remaining portions of the photoresist material that correspond to spaces between the herringbone structures to be formed in the substrate 910. As shown in FIG. 9E, portions of the hard mask 912 exposed through the patterned photoresist layer 914 are etched, preferably using an isotropic etchant. The isotropic etchant may be a wet etchant, such as, for example, hydrofluoric acid or other isotropic wet etchants used in typical glass/fused silica glass etching techniques. During the isotropic etch, the hard mask 912 is undercut, resulting in the formation of raised features or protrusions 916 in the substrate 910. For example, as shown in FIG. 9E, the etch step results in formation of two channels 911, 913, and as the etch progresses, the two channels 911, 913 merge into one another, leaving a lip or dot corresponding to the protrusions 916 between the two merged channels 911, 913. As shown in FIGS. 10A and 10B, the patterning of the photoresist layer 914 and subsequent etching of the hard mask 912 and underlying substrate 910 may be controlled to obtain the desired herringbone structure. Specifically, in the exemplary embodiment shown in FIG. 10A, the protrusions 916 forming the herringbone ridge structures are formed in the bottom of the channel, while in the exemplary embodiment shown in FIG. 10B, the protrusions 916 forming the herringbone ridge structures are formed in the bottom of the channel and also extend up the sidewall of the channel.

In an exemplary embodiment, a mixer formed using the steps shown in FIGS. 9A-9E may include a channel having a width of 400 μm, with six herringbone structures per one half cycle. The raised feature height (that is, the height of the herringbone ridge structures) may be characterized as a function of a line's width and etch depth. The term “line width” may refer to the width of each herringbone structure. For example, the line width may be empirically derived from the process as spaces are opened at approximately twice the etch depth (e.g., within a range of 2-3 times the etch depth). For example, a 10 um space etch to 50 um depth would yield a final CD of ˜110-150 um.

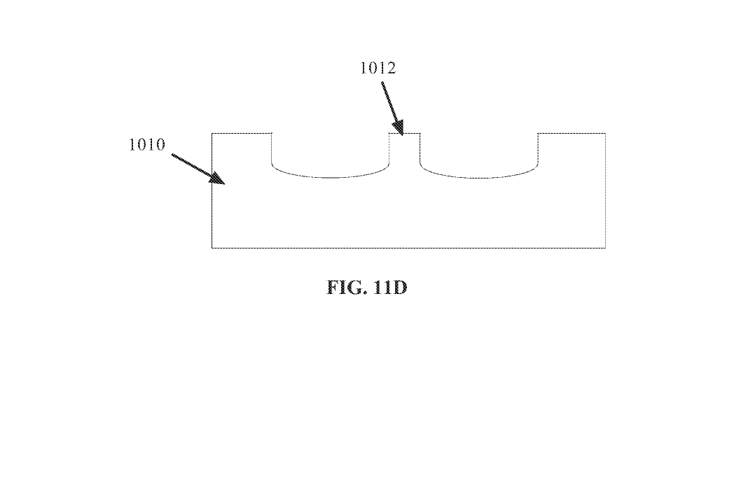

FIGS. 11A-11D are cross-sectional views showing various steps of a method for forming a mixer chip according to another exemplary embodiment of the present invention. As shown in FIG. 11A, a substrate 1010 is provided. The substrate 1010 may be made of a photostructurable glass, such as, for example, APEX™ glass, manufactured by Life BioScience, Inc., Albuquerque, N. Mex., USA, and Foturan™ glass, manufactured by Schott Glass Corp., Elmsford, N.Y., USA. As shown in FIG. 11B, portions of the substrate 1010 are exposed to light, such as, for example, UV-light, using a photolithography technique. The exposed portions of the substrate 1010 may correspond to the spaces between herringbone structures to be formed in the substrate 1010. As shown in FIG. 11C, the exposed substrate 1010 is baked to activate the exposed material in the substrate 1010. As shown in FIG. 11D, an anisotropic wet etch process is performed to remove the activated portions of the substrate 1010, resulting in protrusions 1012 in the substrate 1010 that conform to the herringbone structures of the mixer channel.

Now that the exemplary embodiments have been shown and described in detail, various modifications and improvements thereon will become readily apparent to those skilled in the art. Accordingly, the spirit and scope of the present disclosure is to be construed broadly and not limited by the foregoing specification.

What is claimed is:

1. A microfluidic mixer comprising:
one or more mixer channels, each of the mixer channels comprising at least one glass surface on which are formed protrusions arranged in a herringbone pattern.

2. The microfluidic mixer of claim 1, wherein the glass surface is made of fused silica or borosilicate glass.

3. The microfluidic mixer of claim 1, wherein at least one glass surface of at least one mixer channel forms a bottom wall of the at least one mixer channel, and the protrusions are formed only in the bottom wall.

4. The microfluidic mixer of claim 1, wherein at least one glass surface of at least one mixer channel forms a bottom wall and a side wall of the at least one mixer channel, and the protrusions are formed in the bottom wall and extend into the side wall.

5. The microfluidic mixer of claim 1, wherein the protrusions have a height within the range of 1 um to 100 um.

6. The microfluidic mixer of claim 1, wherein a distance between the protrusions is within a range of 1 um to 500 um.

7. A method of forming a microfluidic mixer comprising the steps of:
providing a glass substrate; and
etching the glass substrate so as to form protrusions arranged in a herringbone pattern.

8. The method of claim 7 wherein the etching step is performed using an isotropic etchant.

9. The method of claim 7, wherein the etching step is performed using a wet etchant.

10. The method of claim 1, further comprising a step of forming a patterned hard mask layer over the substrate before the etching step, so that the glass substrate is undercut relative to the patterned hard mask during the etching step.

11. The method of claim 1, wherein the glass is photostructuable glass, and the method further comprises the step of activating portions of the glass substrate so that the activated portions are removed during the etching step.
